(19) United States
(12) Patent Application Publication
(10) Pub. No.: US 2012/0118658 A1
(43) Pub. Date: May 17, 2012

(54) MOTORCYCLE

(76) Inventor: Daniele SABATINI, Roma (IT)

(21) Appl. No.: 13/305,640

(22) Filed: Nov. 28, 2011

(30) Foreign Application Priority Data
Jun. 10, 2010 (IT) RM2010A000316

(51) Int. Cl. B62K 11/00

(52) U.S. Cl. 180/219

(57) ABSTRACT

A motorcycle is described. The motorcycle has an inverted engine with an engine block standing above a thermal assembly, and a fore carriage and a rear carriage positioned at two opposed sides of the engine block. The engine block comprises connection members of the front carriage and connection members of the rear carriage. The connection between the front carriage and the rear carriage is obtained exclusively through the engine block.

### CROSS REFERENCE TO RELATED APPLICATIONS

The present application is related to Italian Patent Application RM2010A000316 filed on Jun. 10, 2010 and incorporated herein by reference in its entirety.

FIELD

The present application relates to an internal combustion engine for motor vehicles with two or three wheels and hereinafter designated for brevity under the term “motorcycle”, designed and constructed according to an innovative architecture and so as to produce implicit performance and effects as well as to accomplish its own and original structural function, as it is better described and illustrated hereinafter according to the first claim and the following ones.

### BACKGROUND

According to pertinent terminology of current use, the motorcycles are characterized by shape, technique and performances as deriving, among other things and in particular, from the geometry usually adopted for the main mechanical components of their own engines that is as induced by placing, in the physical space of the motorcycle, the combustion chamber or chambers, confined inside the thermal group, with respect to the prevailing mass or shape of the engine block containing, among other things, the drive shaft.

In the state of art, the combustion chamber or chambers of the engines for motorcycles are placed on top with respect to the engine block, by summarizing in such generic asset definition any tilting of the single cylinder, that is of one or more cylinders, from the generic vertical axis to the resting or rolling plane of the motorcycle wheels, that is from the orthogonal to the ground, until a maximum limit not higher than an angle of 180 degrees measured according to the sexagesimal system, both in longitudinal direction and in the direction transversal to the motorcycle driving line or direction and even by comprising in such above-mentioned margin or spatial area considerable plus or minus geometric-angular variations. Consequently, the engine block, to be meant both as independent member, which can be separated from the thermal assembly both jointly to the cylinder or to the cylinders as single monobloc and however in relation to its own prevailing technical overall size in shape and/or volume, is never placed above the combustion chamber or chambers if the axis of the drive shaft housed therein is taken as a primary reference and/or as geometrical cornerstone, in the physical space of the motorcycle,. This involves that, in the state of art, all internal combustion engines for motorcycles characterize for the same in principle functional and aesthetical structural architecture, with the engine block placed on the bottom or however not beyond an aligned or half-aligned position with respect to the thermal assembly and/or related combustion chambers, even in order to make that in the engine block itself the lubricating oil is collected or flows by gravity, and even if upon considering all variants usually identified for arrangement or fractioning of the thermal assembly itself as, by only recalling some terminological examples, the single cylinder or multi-cylinder engines, to cylinders arranged vertically or slightly tilted longitudinally and/or transversally, to horizontal cylinders, opposed cylinders, shaped like a “V”, a “L” and so on. These well-known shapes of the engines for motorcycles make the generic motorcycle, in the state of art, equal to a same type derived by the above illustrated traditional arrangements of the thermal assembly with respect to the engine block and vice versa.

Such above-described constraints, related to the whole geometry of the usual engines for motorcycles involve that the natural cooling by convection of the cylinders and/or of the engine block is aerodynamically limited, the cylinders being mainly confined between the engine block and the upper portion of the motorcycle, generally occupied and/or bound by the frame, by the fuel tank or whatever structurally or functionally obstructs in the same way and even if another main or auxiliary cooling system is adopted, for example a liquid system, the heat generated by the thermal assembly with turned-on engine involves a considerable thermal discomfort to the motorcycle driver, in particular above all in case of multi-cylinder engines and/or high-powered engines, as the engine hottest area, that is the heads and the combustion chamber, come to lie just between the driver legs.

Such above-described constraints, related to the geometry of the usual engines for motorcycles, involve that, even if by adopting specific solutions apt to expose as much as possible the cylinders to the aerodynamic flow, even in order as to move away greatly the thermal assembly from the anatomic portions of the driver and/or of the transported passenger that is to reduce the heat quantity transmitted thereto and/or perceived therefrom, by tilting the same cylinders transversally with respect to the motorcycle driving line or direction, it is not possible avoiding, in the state of art, the increase in the engine side overall size, apart from the need of additional mechanical components inside or outside the engine block, such as by way of examples, the cardan drives.

Such above-described constraints, related to the geometry of the usual engines for motorcycles, further involve that the mechanical members of the sucking/power system providing, in dosage and proper phase, the air-fuel mixture necessary to the combustion and to the consequent motion of the piston or of the pistons inside the respective cylinders and, by way of purely not exhaustive indication, called as “carburettor” and/or “butterfly body” and/or injectors, are mainly positioned so that these suck air from the aero dynamical vortexes created by the motorcycle motion and/or heated by the opposite thermal assembly of the engine itself and it should make use of cumbersome sucking ducts to convey denser fresh air, more enriched with carburant oxygen, and then optimal for the engine performance, to the damage of the weight saving and the constructive and aesthetical simplification.

Such above-described constraints, related to the geometry of the usual engines for motorcycles, further involve, independently from the cooling system used for the engine, that it is necessary arranging an autonomous structural system, constructed with any material, size, shape and number of components and designated by way of example with the term “frame”, apt to the connection between the front carriage and the rear carriage that is to the support and/or to the containment of the engine and which further serves as element for supporting or joining the other portions composing the motorcycle such as, by way of not exhaustive example only, the motorcycle construction, the front and rear suspensions, the big fork, the tank, the saddle and anything else constitutes the set of the suspended and/or not suspended masses belonging to the motorcycle, as well as apt to support the driver and the generic passenger.

What above involves that, even if one has recourse to particular stratagems in order to utilize jointly the engine block and/or the thermal assembly properly shaped and/or reinforced to meet the bearing and/or structural function of the generic “frame” mentioned in advance, in the state of art there are currently no engines for motorcycles apt to be assembled with other autonomous components to form a unitary set, even if sufficiently rigid and properly suitable to meet the function of the above-mentioned “frame”, leaving exempted from connection constraints or encumbrances the thermal assembly of the engine itself, both directly and by means of accessory members of any shape, size and material, giving the possibility of reducing the sizes of such above-mentioned components as long as the particular configuration of the engine object to of the present industrial patent application can permit it.

### SUMMARY

The engine according to the present disclosure represents an innovation in the state of art in the production of engines for motorcycles and motorcycles, as it is a propeller with inner combustion characterized, from a morphological, engineering and functioning point of view, by the particular placement, in the physical space, of the combustion chamber or chambers inside the related thermal assembly with respect to the engine block that is with respect to the axis of the drive shaft contained therein. In the engine object of the present patent application the thermal assembly appears to be placed on the bottom and/or faced downwards with respect to the engine block, the latter to be meant detected, in the physical space of the motorcycle, by means of the axis, as geometrical cornerstone, of the drive shaft housed therein, and with the head placed in front of the ground and/or grazing or half-grazing the resting and/or rolling plane of the motorcycle tyres, by comprising in the conformity to the above-mentioned innovative asset of the previously mentioned components of the motorcycle engine object of the present patent application any absolute or mutual variation in angle or position, still belonging to what has been illustrated and described.

The thermal assembly placed in conformity to the architecture of the engine object of the present patent application is exposed to the aero dynamical flow generated by the motorcycle motion without obstacles or limitation imposed by the frame and/or by the blocking of the same thermal assembly between the engine block and the components ending the motorcycle upper profile, such as a simplified example the frame and the fuel tank, by further reducing considerably the quantity of heat intercepted and perceived by the motorcycle driver and/or by the transported passenger.

From such above-mentioned particular and innovative architecture of the engine according to the present disclosure, the intrinsic possibility further follows of exploiting with greater absolute and relative freedom the body of the engine block for what above described, both shaping the engine block itself so as to obtain, in convenient shape, sizes and position, the housing of the steering tube for the connection of the front fork, both as direct or indirect support, of motorcycle components and/or accessories, such as by way of example a pro-frame, the fuel tank, the saddle and anything else. The above illustrated morphological peculiarity of the engine object of the present patent application further allows to the same to be able to meet more rationally and with less quantity of used materials the function of primary member of a rigid and structurally auto-bearing set ended up on the front portion and/or on the rear portion by members with suitable shape, sizes and materials, mutually and not mutually and/or jointly to the engine block of the engine object of the present patent application apt to sustain, support, connect or contain, either directly and/or indirectly, what is useful and/or necessary for operating and/or driving the motorcycle such as, by way of example only, the fork, the front and rear suspensions, the handlebar, the tanks for fuel and/or other liquids, the power system, the discharge system, the saddle, the foot pegs, the big fork, the discharge terminals, the wheels, the electrical and electronic components and anything else necessary.

### BRIEF DESCRIPTION OF THE DRAWINGS

FIG. 1 depicts a lateral view of the motorcycle of the disclosure.

FIG. 2 depicts top and bottom views of the motorcycle of the disclosure.

FIG. 3 depicts front and rear views of the motorcycle of the disclosure.

FIGS.4-7 depict perspective views of the motorcycle of the disclosure.

### DESCRIPTION

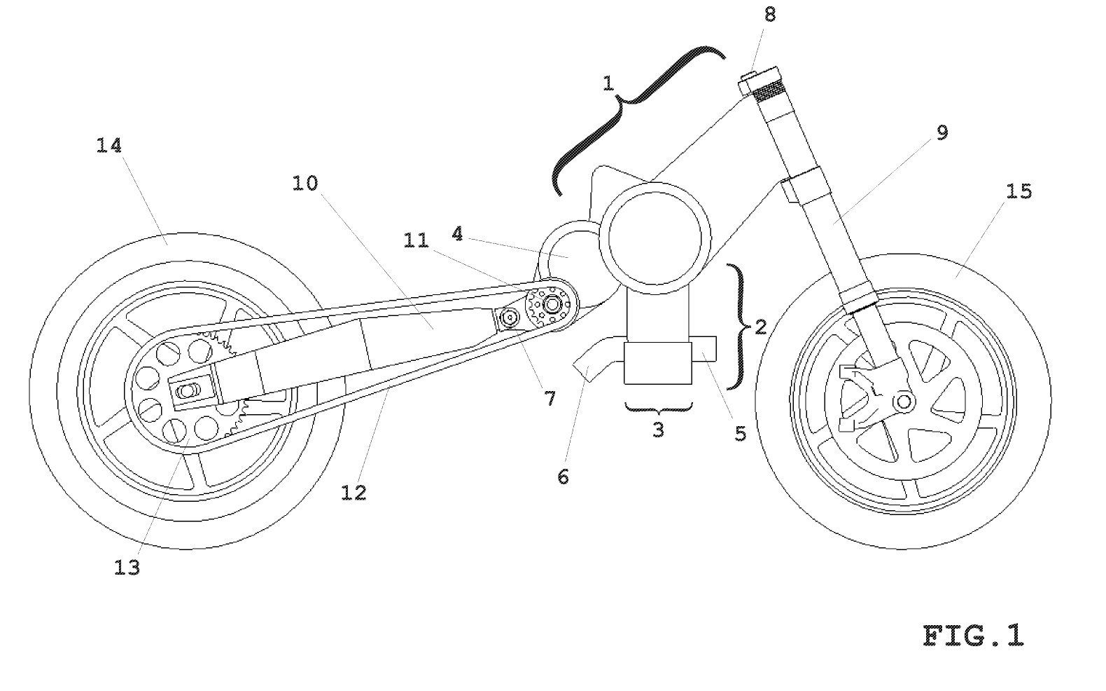

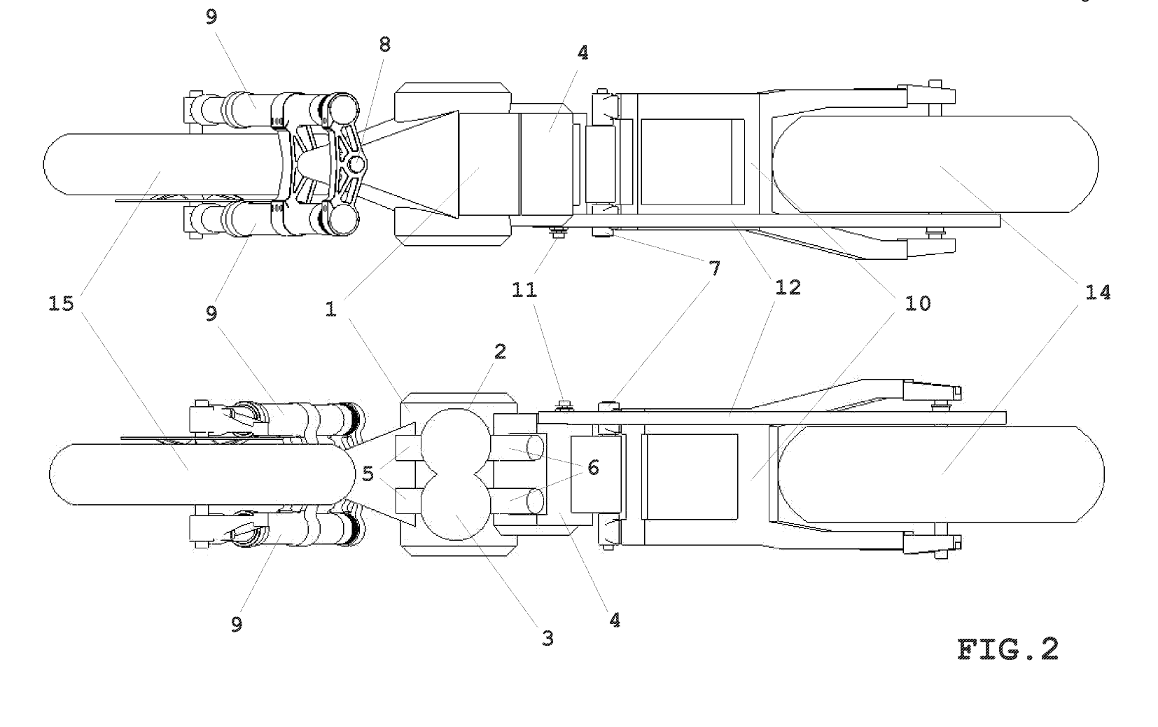

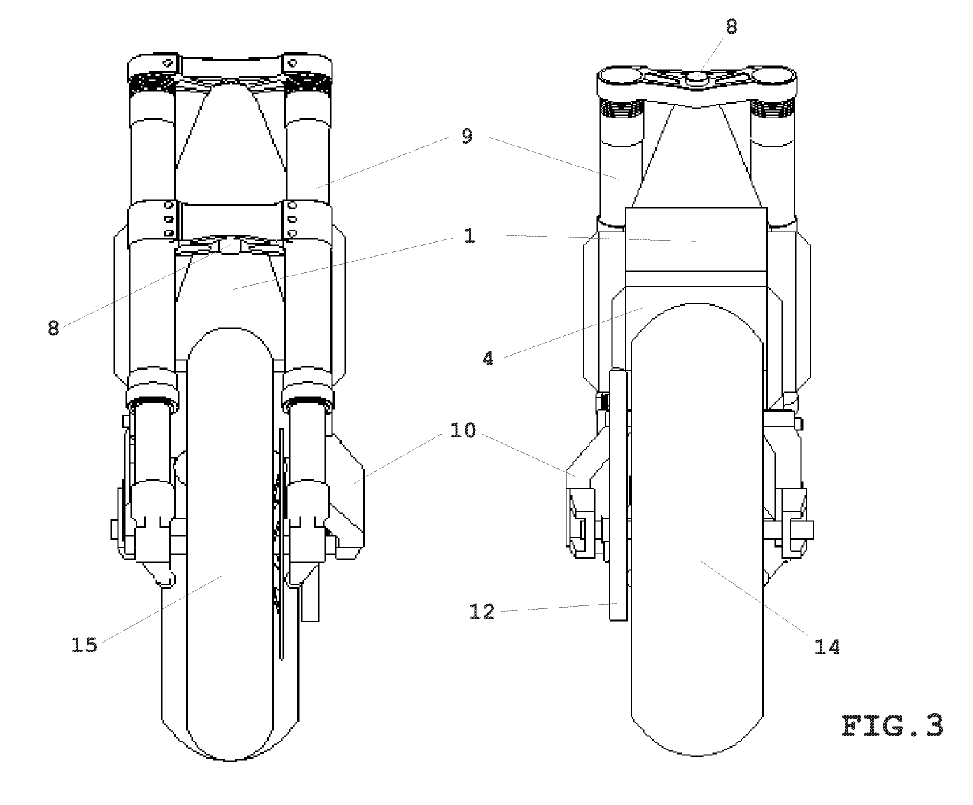

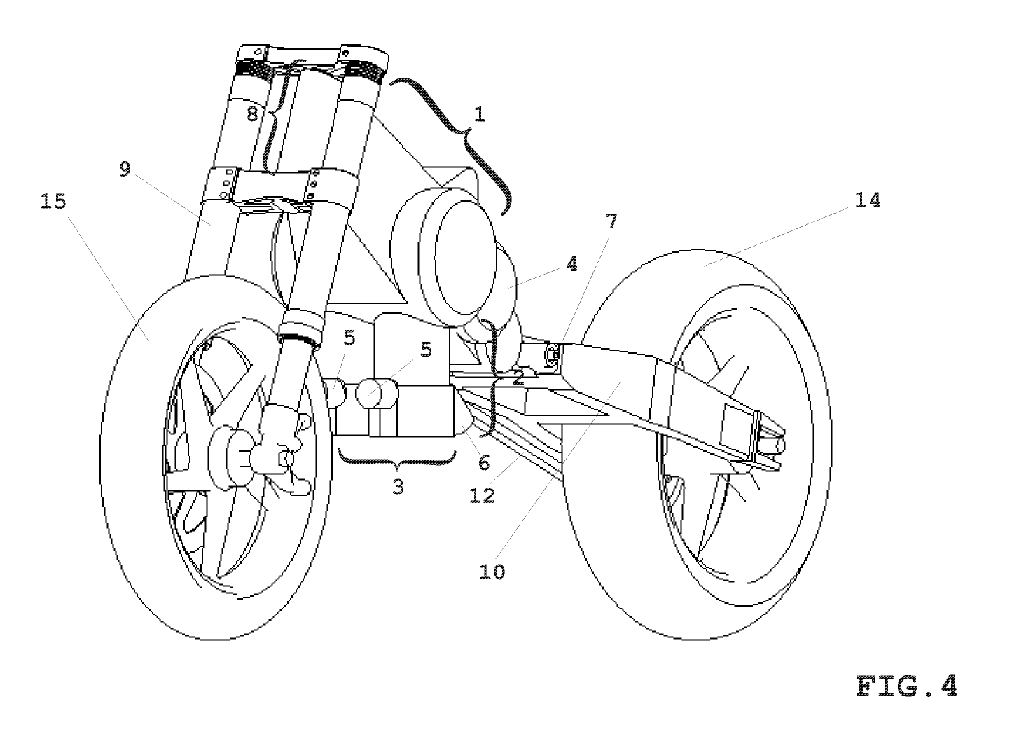

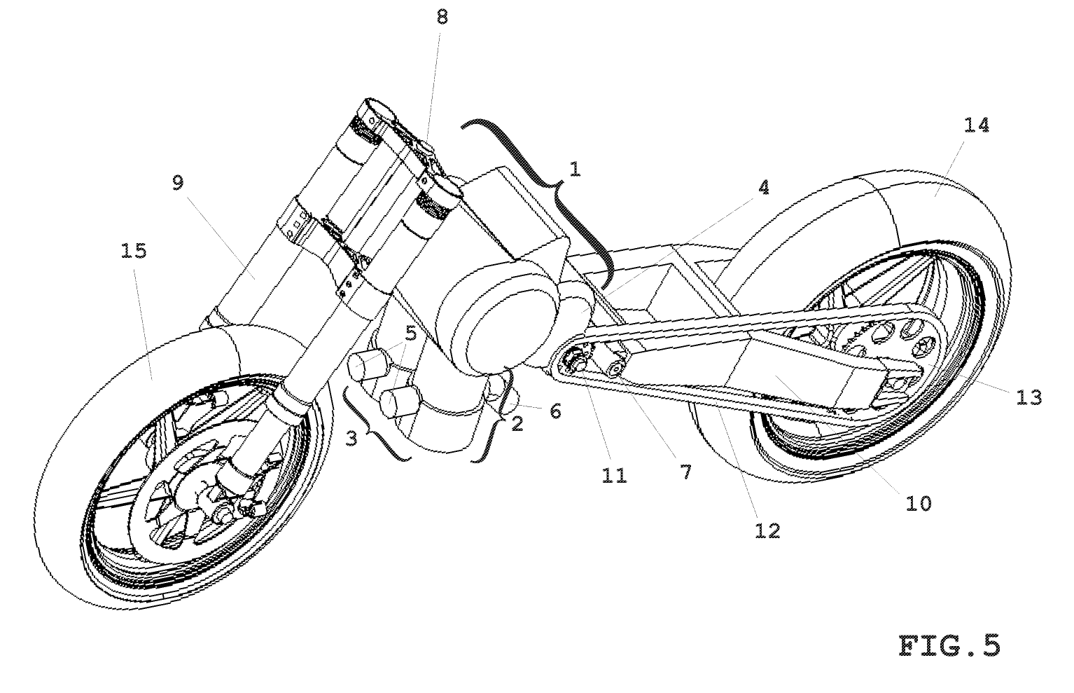

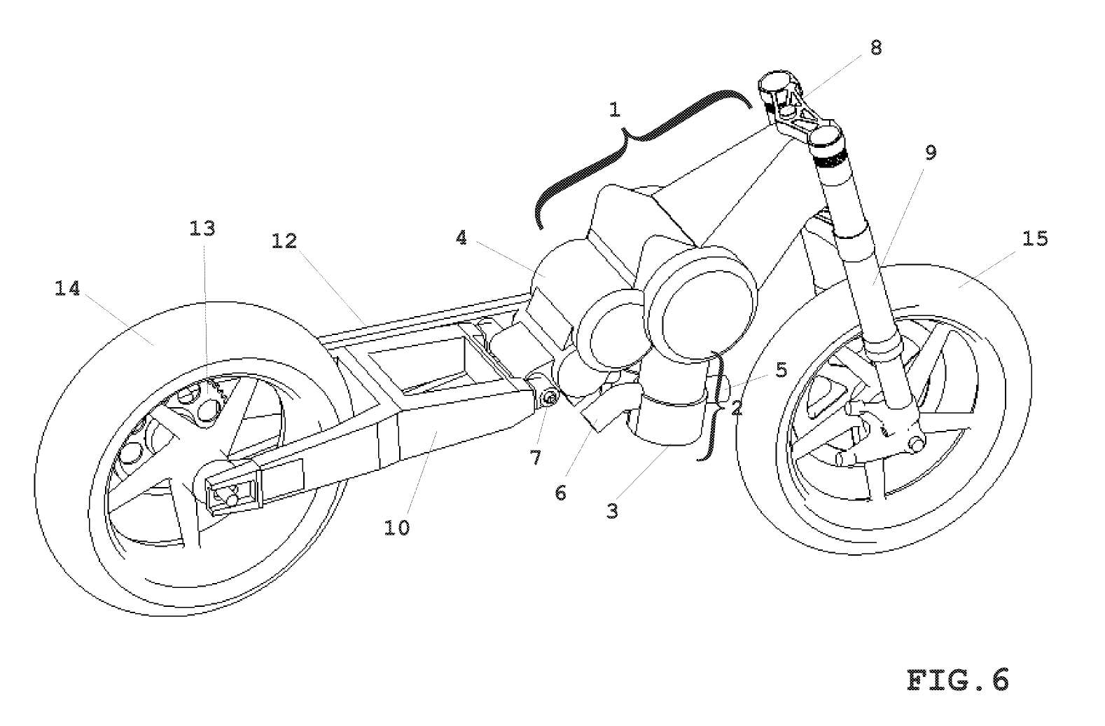

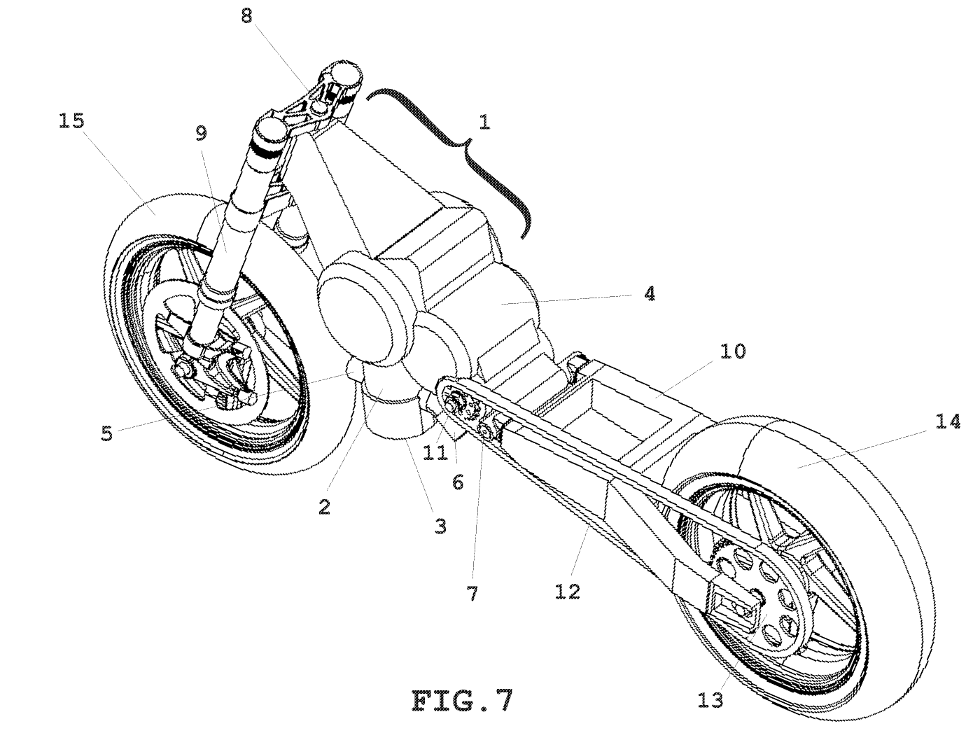

The engine according to the present disclosure, in the shape as illustrated above and/or as equipment of a motorcycle, could by designated, by simplicity, under the term “inverted engine” in the present industrial invention patent application and it will be better described and reproduced hereinafter, by way of example only, by referring to the drawings of FIG. 1, FIG. 2, FIG. 3, FIG. 4, FIG. 5, FIG. 6 and FIG. 7 and/or to the particulars underlined therein as detected with Arabic numbers.

The engine block 1, in raised position with respect to the combustion chambers, includes the drive shaft placed in motion by means of the “piston-rod” system which, in turn, is housed and it is a portion of the underneath thermal assembly 2 equipped with a suitable system for the lubricating and/or refrigerating recovery oil descended by gravity during the engine operation. Such shape allows the cylinders of the thermal assembly 2 and the heads 3 to expose fully and by simple geometry to the aerodynamic flow produced by the moving motorcycle, without additional side hindrances and by reducing considerably the heat sensation perceived by the driver and/or by the transported passenger thanks to the fact of moving away the thermal assembly from the driver's body. The same placement of the thermal assembly 2 makes that the sucking collectors 5, advantageously positioned on the front portion with respect to the thermal assembly and therefore directly in front running position, can receive the charge of additionally cooled fresh air for the possibility of taking advantage of the maximum ventilation from the direct aero dynamical flow, and sucking with greater rationality and less use of materials and components, denser fresh air, more enriched with carburant oxygen, and therefore optimal for the combustion and for the engine performance, with respect to what allowed by the engines for motorcycles existing in the state of art, which, having the sucking collectors placed above or under the thermal assembly must necessarily be equipped with special and long conveying tubes which have the duty of going to pick up and intercept fresh air on the front portion of the motorcycle.

The placement of the discharge collectors 6 allows to equip extremely compact discharge systems, placed wholly on the bottom and therefore as far as possible from the anatomical portions of the motorcycle user with incremental lowering of the centre of gravity with respect to the state of art, better performance yields and greater thermal comfort for the driver and the passenger. The particular “inverted” position of the engine object of the present patent application allows the engine block 1 to house, in suitable seat obtained in its technical volume or by means of an accessory member however firmly connected to the engine block 1, the device for the connection with the front carriage, that is the steering tube 8 wherein the steering base of the front fork 9 is hinged, without preventing, due to this, the engine object of the present patent application to take advantage of an accessory rigid member and/or pro-frame of suitable shape, size and material, replacing and/or helping, alternatively, such above-described function of structural joint between fork 9 and engine block 1 of the engine itself.

The engine block 1 on the rear side is connected to the carter 4 containing in particular the mechanical members of the clutch and of the primary transmission with the related pinion 11 connected by means of a chain 12 to the crown 13 of the drive wheel 14, apart from the possibility of alternatively equipping the motorcycle with a cardan shaft transmission. The rear fork 10 sustaining the above-mentioned drive wheel 14 is hinged connected in the point 7 to the carter 4 and then to the engine block 1. The engine block 1 connected on the front side to the fork 9, supporting the front wheel 15 and on the rear side to the rear fork 10 in the points and/or with the above-mentioned ways forms a single and convenient very rigid structural system, thus very suitable even to a motorcycle of high or very high performances and/or for competition. On such above-described structural system, apart from the front fork 9, the tank, the saddle, the handlebar, the rear damper and all necessary components wholly apt to the motorcycle functionality can be mounted, properly assembled, even if not reproduced in the drawings of the figures for better clarity.

Furthermore, the present disclosure comprises embodiments directed to:

1) Motorcycle equipped with an internal combustion engine object of the present patent application.

2) The engine for motorcycle with inner combustion which is characterized by the particular mutual placement, in the physical space, of the combustion chamber or chambers with respect to the engine block and such that, having assumed as reference geometrical plane a plane coplanar to the rotation axis of the drive shaft, contained inside the engine block, and parallel to a second plane coplanar to the rotation axes of the motorcycle wheels, the combustion chamber or chambers are placed below the above-mentioned reference plane that is below the drive shaft and/or the engine block and, vice versa, the engine block and/or the drive shaft are placed above the combustion chamber or chambers confined in the thermal group.

3) The engine for motorcycle, which is characterized by a particular, transferring and pulsing, moving direction of the piston or the pistons inside the cylinders or other member(s) apt to transmit the motion to the drive shaft and such that the top of the piston or of the pistons mentioned above is always placed, faced and/or directed downwards, that is it always lies below the reference geometrical plane.

4) The engine for motorcycle which is characterized by the particular placing of the thermal assembly head and so that this is grazing or half-grazing the resting and/or rolling plane of the motorcycle tyres.

5) The engine for motorcycle which can be terminologically defined as “inverted engine” with respect to the engines for motorcycles of the state of art.

6) The engine for motorcycle which has a shape so that, without or with the help of a liquid cooling system, the cylinders of the thermal assembly penetrate the aero dynamical flow with effectiveness, freedom and efficiency equal to the one of the engines with cylinders placed integrally horizontally with respect to the motorcycle driving direction and on the axis orthogonal to the axis of the motorcycle driving direction.

7) The engine for motorcycle which has a shape so that, with or without the help of a liquid cooling system, the quantity of heat generated by the thermal assembly and intercepted and/or perceived subjectively by the driver of the motorcycle itself and/or by the passenger is so as to be commensurably lower than the engines for motorcycles in the state of art, as the thermal assembly comes to find much farer than the driver's body.

8) The engine for motorcycle which is shaped so that the engine block can be shaped in order to house directly and properly the steering tube thereto the front carriage, that is the front fork, is to be connected and/or to house directly or indirectly the pin of the big fork.

9) The engine for motorcycle which is shaped so that the technical volume of the engine block can even be connected to the front carriage, that is to the front fork, by means of an accessory rigid member, of generic shape, size and form, even with function of pro-frame and/or proto frame, but without the need of engaging the thermal assembly that is the heads and/or the cylinders of the engine itself.

10) The engine for motorcycle which allows exploiting the body of the engine block and in particular way the upper portion such as autonomous support and/or platform, directly or indirectly, of passive components and/or accessories of the motorcycle, such as, by way of example, radiators, supercharging compressors, starting engines, tanks, saddle, system components and/or electronic and electric apparatuses, batteries, pro-frames and/or proto-frames, saddle-supporting frames and anything else to the purpose according to the art rule.

11) The engine for motorcycle which allows exploiting the position and the shape of the engine block as seat of proper direct and/or indirect connections, according to art rule, with a front member, towards the driving direction, and a rear member, towards the opposite portion, of any material and suitable form and meeting mutually and jointly to the engine block the function of connecting, sustaining, supporting or containing, directly and/or indirectly, what is useful and/or necessary, in components and accessories, as well as to sustain the driver and the possible transported persons, for the operation and/or use of the motorcycle according to the art rule.

12) The engine for motorcycle which allows replacing wholly or partially the use of a structurally independent frame or a pro-frame and/or a proto frame, apt to contain the engine itself as well as to stiffen, sustain and/or transmit and/or join and/or connect the set of the suspended masses of the motorcycle to the not suspended masses of the front carriage and of the rear carriage of the same.

13) The engine for motorcycle which for its particular and innovative shape, allows, by using a less quantity of constructive materials, to obtain a higher stiffness of the motorcycle suspended portion thanks to the arrangement of the structurally self-bearing engine block, along the shorter ideal line connecting the steering tube, the pin of the rear fork and the pin of the rear wheel, being universally recognized to the state of art that the more the components of the frame, of the engine and of the big fork of the motorcycle are arranged in adjacent positions or positions lying on this line, the more a more rigid motorcycle construction is obtained, notoriously more useful to obtain higher dynamic performances of the motorcycle apart from obtaining a saving in terms of use of materials, weight and number of necessary components.

14) The engine for motorcycle which for its particular and innovative shape, allows an easy and total mechanical accessibility without unnecessary disassembling of its important components such as bodies, tanks, frame(s), radiators, saddles, power and/or discharge systems and other superstructures existing on motorcycles in the state of art.

15) The engine for motorcycle which for its particular and innovative shape, allows in the most rational way, thanks to the air sucking collectors advantageously placed on the front side of the thermal group, thus directly in the front running position, to suck with greater rationality and less use of materials and components, denser fresh air, more enriched with carburant oxygen, and therefore optimal for the combustion and the engine performance, with respect to what allowed by the engines for motorcycles existing in the state of art which, having at least one or more sucking collectors placed above or behind the thermal group, to obtain better performances must be necessarily be equipped with special and long conveying tubes which have the duty of going to pick up and intercept fresh air in the motorcycle front side.

16) The engine for motorcycle which for its particular and innovative shape, allows in the most rational way, thanks to the discharge collectors, all placed on the rear side of the thermal group, to assume higher temperatures, thus more advantageous temperatures for expelling the dead gases and thus for the better engine performance.

17) The engine for motorcycle which for its particular and innovative shape, allows in the most rational and innovative way, to obtain such set of improvements in the mechanics, dynamics, constructive simplicity, economy of materials, mechanical accessibility, total exposition of the engine, comfort for driver and passenger, so as to be able to make innovations radically in the shape itself, function and therefore aspect of the motorcycle as intended in the state of art.

A number of embodiments of the disclosure have been described. Nevertheless, it will be understood that various modifications can be made without departing from the spirit and scope of the present disclosure. Accordingly, other embodiments are within the scope of the following claims.

1. A motorcycle comprising
an inverted engine comprising an engine block standing above a thermal assembly; and
a fore carriage and a rear carriage positioned at two opposed sides of said engine block, wherein said engine block comprises:
first connection members of said front carriage; and
second connection members of said rear carriage,
and wherein the connection between said front carriage and said rear carriage is obtained exclusively through said engine block.

2. The motorcycle according to claim 1, wherein said front carriage comprises at least: a steering tube, a front fork, a front wheel, and a front suspension.

3. The motorcycle according to claim 1, wherein said first connection members are adapted to connect directly said steering tube of said front carriage to said engine block.

4. The motorcycle according to claim 3, wherein said first connection members comprise a first frame portion bearing one or more components of the front carriage.

5. The motorcycle according to claim 1, wherein said rear carriage comprises at least: a rear fork, a rear suspension, and transmission members.

6. The motorcycle according to claim 1, wherein said second connection members are adapted to connect directly the rear fork of said rear carriage to said engine block.

7. The motorcycle according to claim 6, wherein said second connection members comprise a second frame portion bearing one or more components of said rear carriage.

8. The motorcycle according to claim 1, wherein said thermal assembly additionally comprises a system for recovering the lubricating oil.
